(19) United States
(12) Patent Application Publication
(10) Pub. No.: US 2016/0203537 A1
(43) Pub. Date: Jul. 14, 2016

(54) INTEGRATED SYSTEM OF GOODS OR SERVICES

(71) Applicant: Shau-Liang Chen, Taoyuan City (TW)

(72) Inventors: Shau-Liang Chen, Taoyuan City (TW); Chun-Hsien Lee, Taoyuan City (TW); Ping-Hsien Li, Taoyuan City (TW)

(21) Appl. No.: 14/857,175

(22) Filed: Sep. 17, 2015

(30) Foreign Application Priority Data
Sep. 17, 2014 (TW) TW103132013
Sep. 17, 2014 (TW) TW103132014

(51) Int. Cl. G06Q 30/06; H04B 5/00; G06Q 30/02

(52) U.S. Cl. CPC G06Q 30/0623; G06Q 30/0267; H04B 5/0056; H04B 5/0031

(57) ABSTRACT

An integrated system of goods or services includes a carrier; a near-field communication chip having an identification code; a cloud platform having an authentication data and a goods or services data, the authentication data and the identification code having a correspondence, the goods or services data and the authentication data having a relationship; and a mobile application program product installed a mobile device having a near-field communication sensing module. When the carrier, the near-field communication chip and the mobile device are within an operating area range, the identification code sensed by the near-field communication sensing module is wirelessly transmitted to the cloud platform through the mobile device. When the identification code matches with the correspondence, the goods or services data matching with the relationship are wireless transmitted to the mobile device and executed on the mobile device via the mobile application program product.

### BACKGROUND

1. Technical Field

The present application relates to an integrated system of goods or services, particularly to an integrated goods or services system combining a near-field communication chip with a mobile application program product.

2. Related Art

The population of mobile web browsing enhances the data transmission demand. People are so relied on the mobile devices in the modern society, which makes the data quantity massively increase nowadays. The diversified sources of the data are complicated and contain new and old, and true and fake information.

Traditional BI or data warehouse is good at dealing with the structured data, i.e. the data stored in the rational database, but not for semi-structure data such as XML, Logs, Click-Stream, RFID Tags, etc., i.e. the unstructured data of webpage, email, multimedia, real-time message, not to say the explosive and vast data for today.

Therefore, facing the condition of massive and complex data, it is difficult to use the traditional tools such as data warehouse, data mining, etc. for collecting useful information data as the resources for analysis to obtain helpful results for promoting the competitive strength of an enterprise.

In view of forgoing, it is necessary to effectively collect the information data from the mobile web browsing users, so as to realize a system and method with a good information integrated structure for statistics and analyses, and provide the industrials with valuable results.

### BRIEF SUMMARY

The present application provides an integrated system of goods or services including a carrier; a first near-field communication chip having a first identification code; a cloud platform having a first authentication data and a first goods or services data, the first authentication data and the first identification code having a first correspondence, the first goods or services data and the first authentication data having a first relationship; and a mobile application program product capable of being installed in and executed on a mobile device having a near-field communication sensing module. When the carrier, the first near-field communication chip and the mobile device are within an operating area range, the near-field communication sensing module is triggered by the first near-field communication chip to retrieve the first identification code, and the first identification code is wirelessly transmitted to the cloud platform through the mobile device. When the first identification code matches with the first correspondence, the first goods or services data matching with the first relationship are wireless transmitted to the mobile device and executed on the mobile device via the mobile application program product.

The present application provides an integrated system of goods or services including a plurality of carriers; a plurality of near-field communication chips, each near-field communication chip having an identification code, different near-field communication chips having different identification codes; a cloud platform having a plurality of authentication data and a plurality of goods or services data, each authentication data and each identification code having a correspondence, each goods or services data and each authentication data having a relationship; a plurality of mobile devices, each having a near-field communication sensing module; and a mobile application program product capable of being installed in and executed on the mobile devices. When any one of the carriers, any one of the near-field communication chips and any one of the mobile devices are within an operating area range, the near-field communication sensing module is triggered by the near-field communication chip to retrieve the identification code, and the identification code is wirelessly transmitted to the cloud platform through the mobile device. When the identification code matches the correspondence, the goods or services data matching the relationship is wireless transmitted to the mobile device and executed on the mobile device via the mobile application program product.

According to the present application, the information data from the mobile web browsing users can be effectively collected, so that a system and method with a good information integrated structure for statistics and analyses can be realized to provide the industrials with valuable results.

### BRIEF DESCRIPTION OF THE DRAWINGS

FIG. 1 shows an integrated system of goods or services according to one preferred embodiment of the present application.

FIG. 2 shows an integrated system of goods or services according to another preferred embodiment of the present application.

FIG. 3 shows an integrated system of goods or services according to still another preferred embodiment of the present application.

FIG. 4 shows a multi-dimensional data matrix according to one preferred embodiment of the present application.

### DETAILED DESCRIPTION

According to the preferred embodiments of the present application, an integrated system of goods or services includes a carrier; a near-field communication chip having an identification code; a cloud platform pre-built an authentication data having a correspondence with respect to the identification code, and a goods or services data having a relationship with respect to the authentication data; a mobile device having a near-field communication sensing module; and a mobile application program product stored in the cloud platform and capable of being downloaded by the mobile device for installation and execution. When the carrier, the near-field communication chip and the mobile device are within an operating area range, the near-field communication sensing module of the mobile device senses the identification code within a short distance and retrieves the identification code to be wirelessly transmitted to the cloud platform for authentication. If the identification code passes the authentication of the authentication data, the pre-built goods or services data are executed on the mobile device via the mobile application program product. Moreover, the mobile application program product can execute a service exchange parameter stored in the near-field communication chip, such as executing functional program, retrieving data content or connecting to a predetermined address.

According to the preferred embodiments of the present application, within the short distance is based on the near-field communication technology, which is a short-distance data exchange technology within a distance of 20 cm and a frequency of 13.56 MHz, no matter whether the transmission rate is 106 Kbit/sec, 212 Kbit/sec or 422 Kbit/sec. The present application performs the short-distance sensing to retrieve the only one identification code of the near-field communication chip and then completes the later authentication process. The short-distance and passive near-field communication chip is for one-on-one data exchange, which is different from RFID for one-on-many and long-distance data exchange technology. The near-field communication chip of the present application mainly uses a passive chip; however, using an active near-field communication chip still can be within the scoop of the present application if the short-distance and one-on-one data exchange is adopted.

According to the preferred embodiments of the present application, the user data will be uploaded to the cloud platform for collection and analysis to develop the potential customers so that conditional data can be fed back to the customers. That is, the present application provides an advertisement broadcasting mechanism for the user to receive the feedback so the object for marketing can be achieved.

According to the preferred embodiments of the present application, the operating area range is defined according to the short-distance near-field communication technology. Within the operating area range, users utilize the mobile device to sense the only one identification code of the near-field communication chip and after passing the authentication the goods or services data are transmitted back to the mobile device for execution, so the users will feel a physical connection of the carrier with the goods or services data. The operating area range can mean the carrier, the near-field communication chip and the mobile device are within a range that the users can see or hear.

According to the preferred embodiments of the present application, the near-field communication chip and the carrier can be attached with each other by a dividable way or an undividable secure way. For the dividable secure way, the carrier and the near-field communication chip are temporarily adhered, sucked or bound together. The near-field communication chip separate from the carrier still works, so the near-field communication sensing module still can sense and retrieve the identification code of the near-field communication chip within the short distance. Alternatively, for the undividable secure way, after the near-field communication chip is separately from the carrier, the near-field communication chip is broken so the near-field communication sensing module cannot sense and retrieve the first identification code of the first near-field communication chip anymore.

According to the preferred embodiments of the present application, the execution means when the goods or services data are digital data, the mobile application program product can be executed for downloading or streaming playing the digital data; when the goods or services data are an application program, the mobile device can operate the application program. The present application utilizes the streaming transmission technology, and the users have to utilize the near-field communication sensing module for sensing the near-field communication chip to execute the goods or services data.

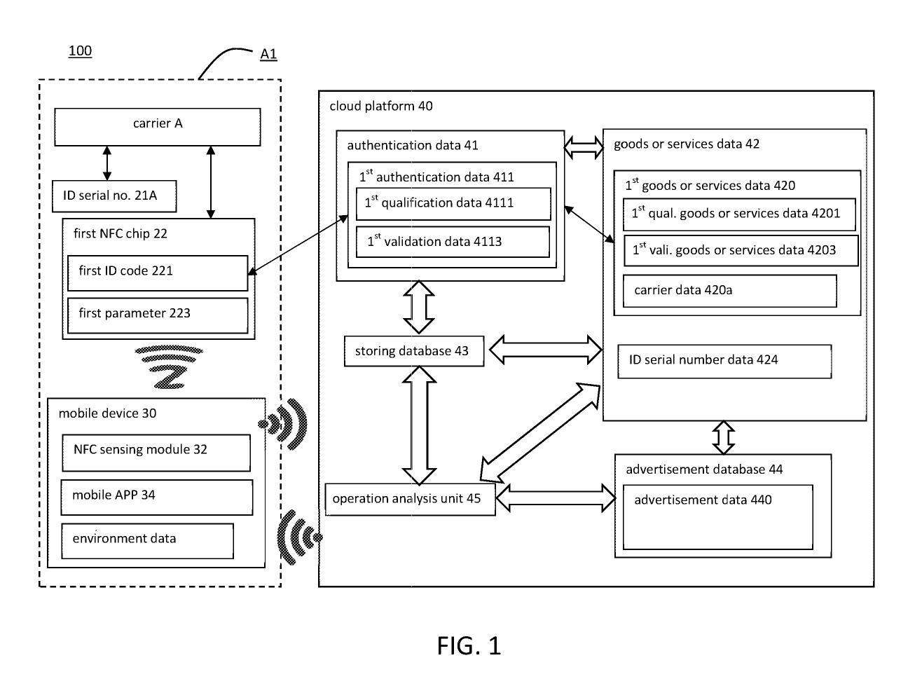

FIG. 1 shows an integrated system of goods or services 100 according to a preferred embodiment of the present application, which includes a carrier A, a first near-field communication chip 22, a mobile device 30 and a cloud platform 40. The carrier A, and the first near-field communication chip 22 including a first identification code 221 are within an operating area range Al. The mobile device 30 includes a near-field communication sensing module 32, a mobile application program product 34 and environment data 36. The cloud platform 40 includes authentication data 41, goods or services data 42, a recording and storing database 43, an advertisement database 44 and an operation analysis unit 45.

The near-field communication sensing module 32 of the mobile device 30 is preferably triggered within a distance of 20 cm and a frequency of 13.56 MHz, but not limited thereto. However, the near-field communication sensing module 32 of the present application can only be triggered one at a time by one near-field communication chip. That is, in the present application, the near-field communication sensing module 32 can only be triggered by the near-field communication chip 22 but will not be triggered by other near-field communication chips. When the near-field communication sensing module 32 is triggered to retrieve the first identification code 221 and activate the mobile application program product 34, the first identification code 221 of the near-field communication chip 22 can be wirelessly transmitted to the cloud platform 40, and the environment data 36 of the mobile device 30 can also be wirelessly transmitted to the recording and storing database 43 via the mobile application program product 34. The environment data 36 may include but not limit to a mobile device identification data (such as a chip identification or phone number of the mobile device 30), time data, location data or application program parameter data, etc., as long as the data in the mobile device 30 are legally obtained and can be further used for analysis. The environment data 36 can be transmitted when the Internet connection is available or under a predetermined schedule, and the wireless transmission can be done by any wireless connection through Wi-Fi, 3G or 4G to the cloud platform 40. In the preferred embodiments, the first chip 22 may not be limited to the NFC (near-field communication) chip, the mobile device 30 may include but limit to a smart phone, a notebook computer or a tablet computer. The mobile application program product 34 can be activated before or after retrieving the first identification code 221. The mobile application program product 34 may be stored in the cloud platform 40, such as Google Play® of the Android® system or App Store® of the Apple® system, so the mobile device 30 can download the mobile application program product 34 from the cloud platform 40. In other preferred embodiments, the near-field communication sensing module 32 may retrieve a first service exchange parameter 223 in the first near-field communication chip 22 to directly activate the corresponding operation, such as executing functional program, retrieving data content or connecting to a predetermined address, according to the first service exchange parameter 223.

The cloud platform 40 is a relational database and can exchange data by wireless transmission with the mobile device 30. In other preferred embodiments, the recording and storing database 43, the advertisement database 44 and the operation analysis unit 45 can be excluded from the cloud platform 40, and the data are stored to the mobile device 30 via the mobile application program product 34.

In the preferred embodiment, the authentication data 41 include first authentication data 411, and the goods or services data 42 include a first goods or services data 420. A first correspondence is preset between the first authentication data 411 and the first identification code 221, and a first relationship is preset between the first authentication data 411 and the first goods or services data 420. The first correspondence makes the first authentication data 411 capable of authenticating the first identification code 221. When the first identification code 221 matches the first correspondence, i.e. passing the authentication from the first authentication data 411, the first goods or services data 420 having the first relationship with the first authentication data 411 can be executed on the mobile device 30 via the mobile application program product 34.

In the preferred embodiment, the first authentication data 411 further includes a first qualification authentication data 4111 and a first validation authentication data 4113, and the first goods or services data 420 further includes a first qualification goods or services data 4201 and a first validation goods or services data 4203. A first qualification correspondence is preset between the first identification code 221 and the first qualification authentication data 4111, and a first validation correspondence is preset between the first identification code 221 and the first validation authentication data 4113. Similarly, a first qualification relationship is preset between the first qualification authentication data 4111 and the first qualification goods or services data 4201, and a first validation relationship is preset between the first validation authentication data 4113 and the first validation goods or services data 4203. When the retrieved first identification code 221 passes the authentication from the first qualification authentication data 4111 and/or from the first validation authentication data 4113, the first qualification goods or services data 4201 matching with the first qualification relationship and/or the first validation goods or services data 4203 matching with the first validation relationship can be transmitted and executed on the mobile device 30 via the mobile application program product 34.

In the preferred embodiment, the authentication may be operated but not limit to by checking the first identification code 221 to determine if the near-chip communication chip 22 is a chip authorized by the integrated system of goods or services 100. The first qualification goods or services data 4201 may include but not limit to a serial number, a characteristic code or a keyword of the goods or services.

In other preferred embodiments, the first goods or services data 420 further includes a carrier data 420a, such as a carrier serial number, a carrier classification, a carrier name, a carrier configuration, an industrial classification, a carrier keyword, a chip installation date, an effective date, a service connection or content, an application classification and a contact person, etc., corresponding to the carrier A The carrier data 420a is determined by the carrier A, which can be determined by various requirements or favors depending on different carrier objects or diversity of the carrier configuration, such as but not limit to a specific LOGO or drawing designed for the different carrier objects based on the business request. When the first identification code 221 passes the authentication from the first qualification authentication data 4111, the carrier data 420a related to the first qualification authentication data 4111 can be totally or optionally executed on the mobile device 30 via the mobile application program product 34.

The first validation authentication data 4113 can be used as a second step authentication for the first identification code 221. That is, after the first identification code 221 passes the authentication from the first qualification authentication data 4111, no matter whether the first qualification goods or services data 4201 is executed on the mobile device 30 via the mobile application program product 34, the first validation authentication data 4113 can be used to further authenticate the first identification code 221. For example, the first validation authentication data 4113 may be but not limit to an authentication of a valid period of date to determine if the first identification code 221 is still within the goods or services providing effective date. When the first identification code 221 passes the authentication from the first validation authentication data 4113, the cloud platform 40 can make the first validation goods or services data 4203 having the first validation relationship with the first validation authentication data 4113 be executed on the mobile device 30. In the preferred embodiment, the first qualification authentication data 4111 corresponds to the first qualification goods or services data 4201, and the first validation authentication data 4113 corresponds to the first validation goods or services data 4203. The first identification code 221 is firstly authenticated by the first qualification authentication data 4111 and then secondly authenticated by the first validation authentication data 4113. The first goods or services data 420 can be set up as two-step data in actual use, i.e. the first qualification goods or services data 4201 and the first validation goods or services data 4203. For example, the first qualification goods or services data 4201 can be but not limit to the free-of-charge data content, and the first validation goods or services data 4203 can be but not limit to the fee-charging data content.

After the first identification code 221 is wirelessly transmitted to the cloud platform 40, the recording and storing database 43 not only records the first identification code 221 but also records and collects the environment data 36 of the mobile device 30. As mentioned above, the environment data 36 may include but not limit to the mobile device identification data (such as a chip identification or phone number of the mobile device 30), time data, location data or application program parameter data, etc. The application program parameter data can be, for example, the face book® public data, web browsing time and usage data of the mobile device 30, etc.

In other preferred embodiments, under the arrangement of the first qualification goods or services data 4201 and the recording and storing database 43, the recording and storing database 43, except for the above-mentioned recording function, can be set up with a screening and filtering function. For example, only matching with the preset first qualification goods or services data 4201 and/or the data in the recording and storing database 43, the cloud platform 40 is allowed to transmit the first validation goods or services data 4203. The first qualification goods or services data 4201 may include but not limit to preset a specific carrier configuration and the recording and storing database 43 is preset a period of time data, and only when the first qualification goods or services data 4201 and/or the data in the recording and storing database 43 match the preset conditions, the system is open to execute the first validation goods or services data 4203.

The advertisement database 44 includes the advertisement data 440 such as advertising code, source, catalog and keyword, a fee-charging advertisement, an exhibition and selling location, a storage volume and model number for the advertising physical product, an advertisement broadcasting characteristic code, an advertising content or connection, etc.

The operation analysis unit 45 makes keyword comparison through the first goods or services data 420 and the advertisement data 440. For example, the carrier keyword or a service keyword is used for searching the advertising keyword by a fuzzy comparison to extract both exact matching and partial matching keyword quantity, and operate an optimized broadcasting sequence, and then the advertisement data 440 is sequentially broadcasted via the mobile application program product 34 or conditionally broadcasted according to the advertisement broadcasting characteristic code, such as limited broadcasting time or zone. In the preferred embodiment, the recording and storing database 43 can be cooperated to find the optimized broadcasting sequence. The operation analysis unit 45 makes a cross comparison from the information among the authentication data 41, the first goods or services data 42, the recording and storing database 43 and the advertisement database 44 to predict the consumer trends. After each time a user utilizes the first near-field communication chip 22 to obtain the first goods or services data 420, a using habit and interest and different using habits and interests are correspondingly recorded so that user and marketing data can be built for an advertisement provider to obtain a market responding result with respect to each marketing information directly from a user analysis database, and to further plan different marketing actions according the market responding results, i.e. the so called data mining and big data analysis and etc.

In other preferred embodiments, an identification serial number 21A is further included in the operating area range Al, which may include but not limit to a two dimensional bar code or a QR (Quick Response) code made as a sticker attached on the carrier A. The goods or services data 42 includes a preset identification serial number data 424 corresponding to the identification serial number 21A. In the preferred embodiment, via the near-field communication sensing module 32 retrieving the first identification code 221 within a short distance, and transmitting the retrieved first identification code 221 to the cloud platform 40 for authentication, when the first identification code 221 and the first authentication data 411 match with the preset first correspondence, the identification serial number data 424 corresponding to the identification serial number 21A is wirelessly transmitted to the mobile device 30 by the cloud platform 40, and executed on the mobile device 30 via the mobile application program product 34.

In other preferred embodiments, when the retrieved first identification code 221 matches the preset first correspondence, the cloud platform 40 will request for the user of the mobile device 30 via the mobile application program product 34 to transmit the identification serial number 21A to the cloud platform 40 for authentication. If there is the identification serial number data 424 corresponding to identification serial number 21A, the first goods or services data 420 matching with the first relationship is wirelessly transmitted to the mobile device 30 by the cloud platform 40, and executed on the mobile device 30 via the mobile application program product 34.

In the preferred embodiment, the first near-field communication chip 22 can be attached on the carrier A by a dividably secured connection or an undividably secured connection. For the dividably secured connection, such as but not limit to temporarily adhere, suck or bind the carrier A and the near-field communication chip 22 together, after the first near-field communication chip 22 is separated from the carrier A, the first identification code 221 of the first near-field communication chip 22 can be still successful retrieved by the near-field communication sensing module 32 within the short distance. Alternatively, for the undividably secured connection, after the first near-field communication chip 22 is separately from the carrier A, the first near-field communication chip 22 is broken and the first identification code 221 of the first near-field communication chip 22 cannot be retrieved by the near-field communication sensing module 32.

In the above-mentioned embodiments, the first authentication data 411 including the first qualification authentication data 4111 and the first validation authentication data 4113 can perform the two-step authentication. However, in different embodiments, authentication can be performed only in one step or more than two steps. The first goods or services data 420 may correspond to different step setting of the first authentication data 411 to be classified into different corresponding content, and set up a corresponding relationship between a classified goods or service data and an authentication data in different step.

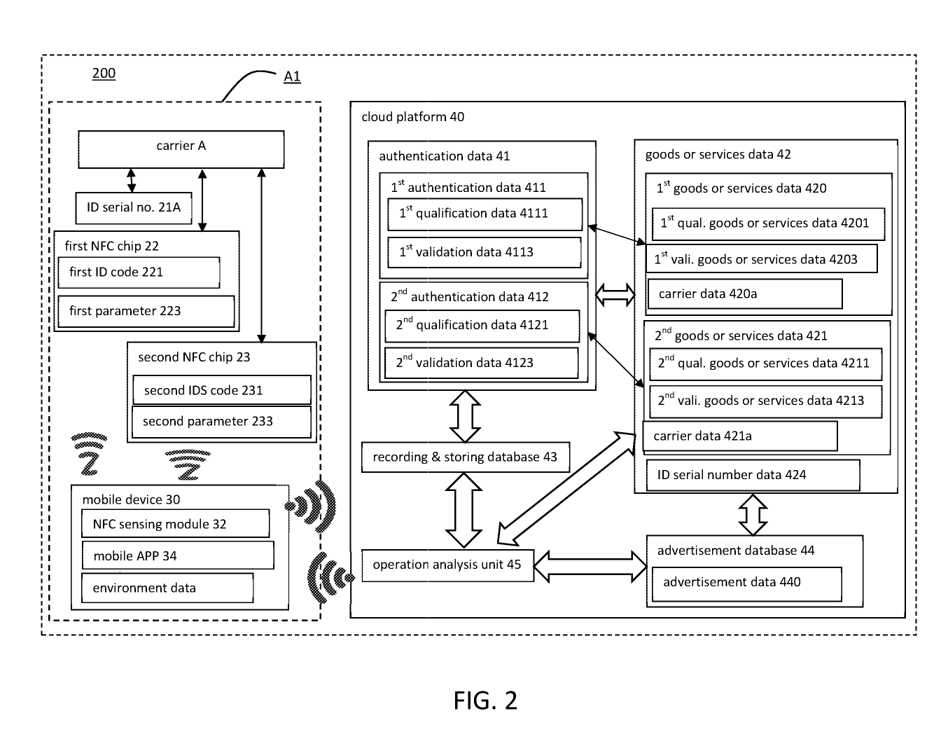

Please refer to FIG. 2. Only those elements not shown in FIG. 1 will be described in detail as follows. In the preferred embodiment, an integrated system of goods or services 200 further includes a second near-field communication chip 23. The carrier A, the first near-field communication chip 22 and the second near-field communication chip 23 including a second identification code 231 are within the operating area range A1. The authentication data 41 further include a second authentication data 412, and the goods or services data 42 further include a second goods or services data 421. The second authentication data 412 and the second identification code 231 have a second correspondence, and the second goods or services data 421 and the second authentication data 412 have a second relationship. The cloud platform 40 receives the second identification 231 retrieved by the mobile device 30 in the short distance, and when the second identification 231 matches the second correspondence, the second goods or services data 421 matched with the second relationship is wirelessly transmitted by the cloud platform 40 and executed on the mobile device 30 via the mobile application program product 34. In other preferred embodiments, the mobile application program product 34 can activate the corresponding actions, such as activating functional program, retrieving data or connecting to the predetermined address.

The second authentication data 412 further includes a second qualification authentication data 4121 and a second validation authentication data 4123, and the second goods or services data 421 further includes a second qualification goods or services data 4211 and a second validation goods or services data 4213. The second qualification authentication data 4121 and the second identification code 231 have a second qualification correspondence, and the second validation authentication data 4123 and the second identification code 231 have a second validation correspondence. Similarly, the second qualification authentication data 4121 and the second qualification goods or services data 4211 have a second qualification relationship, and the second validation authentication data 4123 and the second validation goods or services data 4213 have a second validation relationship. The second qualification authentication data 4121 is used to authenticate the second identification code 231. When the retrieved second identification code 231 passes the authentication from the second qualification authentication data 4121, the second qualification goods or services data 4211 is executed on the mobile device 30 via the mobile application program product 34. When the retrieved second identification code 231 passes the authentication from the second validation authentication data 4123, the second validation goods or services data 4213 is executed on the mobile device 30 via the mobile application program product 34.

In the preferred embodiment, both of the first authentication data 411 and the second authentication data 412 correspond to the first goods or services data 420. The first authentication data 411 includes the first qualification authentication data 4111 and the first validation authentication data 4113. The second authentication data 412 includes the second qualification authentication data 4121 and the second validation authentication data 4123. The first goods or services data 420 includes the first qualification goods or services data 4201 and the first validation goods or services data 4203. The first qualification authentication data 4111 and the first qualification goods or services data 4201 have the first qualification relationship, and the second qualification authentication data 4121 and the first qualification goods or services data 4201 also have the first qualification relationship. The first validation authentication data 4113 and the first validation goods or services data 4203 have the first validation relationship, and the second validation authentication data 4123 and the first qualification goods or services data 4203 also have the first validation relationship. The identification code of the near-field communication chip is unique. The authentication data 41 corresponding to multiple identification codes are preset in the cloud platform 40, and the correspondences and relationships are respectively built up between the goods or services data 42 and the authentication data 41 according to the actual using demand.

In the above-mentioned embodiments, the first authentication data 411 and the second authentication data 412 correspond to the first goods or services data 420 and second goods or services data 42, respectively. In other preferred embodiments, for example, the first authentication data 411 and the first goods or services data 420 have the first relationship, and the second authentication data 412 and the first goods or services data 420 can also have the same first relationship.

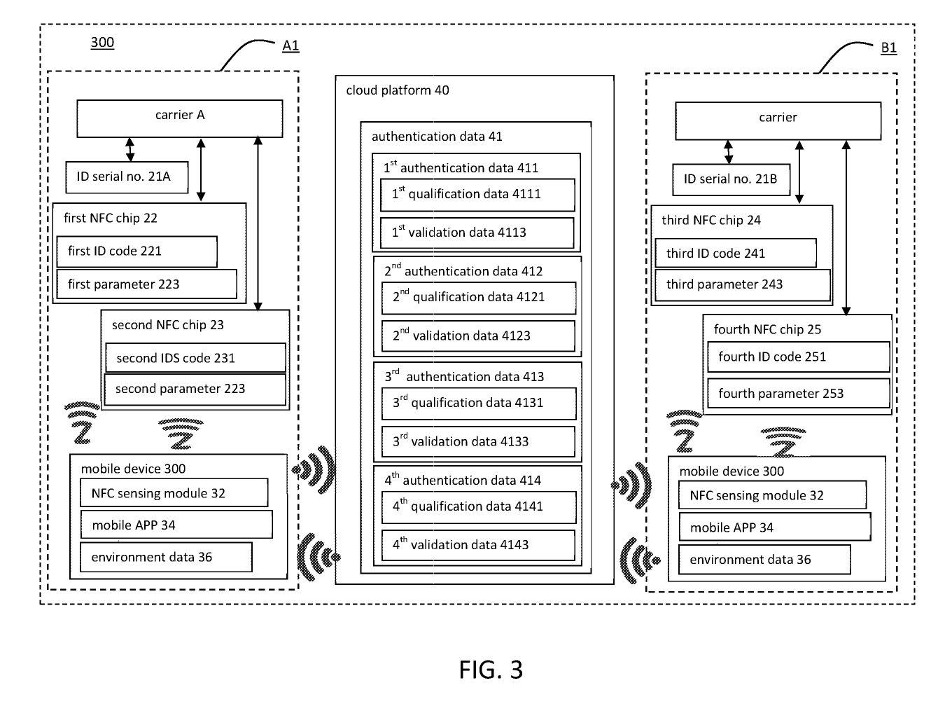

Please refer to FIG. 3. Only those elements not shown in FIG. 1 and FIG. 2 will be described in detail as follows. In the preferred embodiment, an integrated system of goods or services 300 further includes a carrier B, a third near-field communication chip 24, and a fourth near-field communication chip 25. The carrier B, the third near-field communication chip 24 and the fourth near-field communication chip 25 are within the operating area range B1. The third near-field communication chip 24 includes a third identification code 241, and the fourth near-field communication chip 25 includes a fourth identification code 251. The first identification code 221, the second identification code 231, the third identification code 241 and the fourth identification code 251 are different with each other. The third identification code 241 has a third correspondence with a third authentication data 413, and the fourth identification code 251 has a fourth correspondence with a third authentication data 414. The third authentication data 413 further includes a third qualification authentication data 4131 and a third validation authentication data 4133, and fourth authentication data 414 further includes a fourth qualification authentication data 4141 and a fourth validation authentication data 4143. The goods or services data 42 further include a third goods or services data (not shown) and a fourth goods or services data (not shown). The third goods or services data further includes a third qualification goods or services data (not shown) and a third validation goods or services data (not shown). The fourth goods or services data further includes a fourth qualification goods or services data (not shown) and a fourth validation goods or services data (not shown). The first identification code 221 has the first qualification correspondence and the first validation correspondence with respect to the first qualification authentication data 4111 and the first validation authentication data 4113, respectively. The second identification code 231 has the second qualification correspondence and the second validation correspondence with respect to the second qualification authentication data 4121 and the second validation authentication data 4123, respectively. The third identification code 241 has a third qualification correspondence and a third validation correspondence with respect to the third qualification authentication data 4131 and the third validation authentication data 4133, respectively. The fourth identification code 251 has a fourth qualification correspondence and a fourth validation correspondence with respect to the fourth qualification authentication data 4141 and the fourth validation authentication data 4143, respectively. The carrier A and the carrier B can be the same or different. If same, the first authentication data 411, the second authentication data 412, the third authentication data 413 and the fourth authentication data 414 can be preset with the same first relationship with the first goods or services data 420. If different, for example, the carrier A corresponds to the first goods or services data 420 and carrier B corresponds to the second goods or services data 421, the first authentication data 411 and the second authentication data 412 can be preset with the same first relationship with the first goods or service data 420, and the third authentication data 413 and the fourth authentication data 414 can be preset with the same third relationship with the second goods or services data 421.

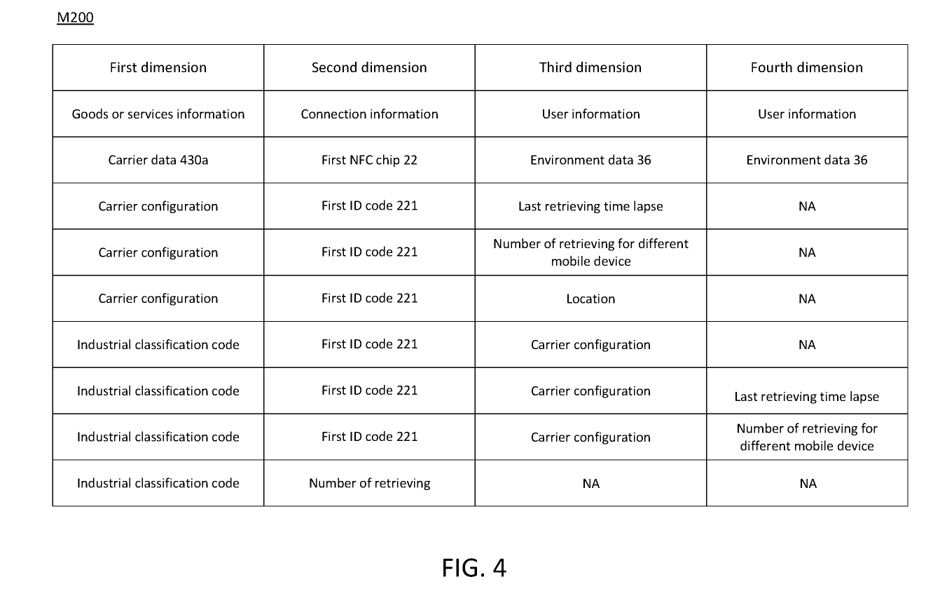

According to the above-mentioned embodiments, the big data analysis can be used to find the potential customers. The goods or services data 42, the carrier data 420a, 421a, advertisement data 440, the identification serial number data 424, the authentication data 41, the environment data 36, etc., of the integrated system of goods or services 100, 200, 300 are systematically analyzed in multiple dimensions. This multi-dimensional analysis utilizes a multi-dimensional data matrix M200 to statistically analyze the relationship of the above-mentioned data in the system. These data can be cataloged into three kinds of different information, i.e. user information, goods or services information and connection information. The user information is related an outside variable information, such as the environment data 36. The goods or services information is a target information for analysis, such as the carrier data 420a, 421a, goods or service data 42 and the advertisement data 440. The connection information is an intermediate information connecting between the variable information and the target information, such as the authentication data 41 and the identification serial number data 424. The relative statistical analysis can be done before or after setting up the dimensions and parameters of the multi-dimensional data matrix M200. In this application, the near-field communication chip is a media to achieve the information interconnection between the mobile device 30 and the integrated system of goods or services 100, 200, 300, and a wide amount of the user information is recorded for analysis. As shown in FIG. 4, a first dimension of the data matrix M200 is the goods or services information, such as the carrier data 420a, 421a which includes the carrier classification, the carrier name, the carrier configuration, the industrial classification, the carrier keyword, the chip installation date, the effective date, the service connection or content, the application classification and the contact person, etc. A second dimension is the connection information, such as the first authentication data 221 and the identification serial number data 424. A third dimension is the user information, such as the environment data 36 which includes the mobile device identification data (such as the chip identification or phone number of the mobile device 30), time data, location data or application program parameter data, etc. The application program parameter data may include the generating data by surfing the Internet, such as the purchase transaction, and may further include a user's replying response. Based on the above-mentioned dimension setting, an effective big data analysis can be achieved. For example, an activity rate for the configuration of the carrier A can be analyzed by using the carrier configuration as the first dimension, the identification code as the second dimension and the environment data 36 including the last retrieving time lapse, number of retrieving for different mobile device, location data, etc. as the third dimension, and an activity rate for the industrial classification can be analyzed by using the industrial classification code as the first dimension, the identification code as the second dimension and the environment data 36 including the last retrieving time lapse, carrier configuration, number of retrieving for different mobile device as the third dimension.

Although the present invention has been described with reference to the foregoing preferred embodiments, it will be understood that the invention is not limited to the details thereof. Various equivalent variations and modifications can still occur to those skilled in this art in view of the teachings of the present invention. For example, carrier data, manufacturer information, client information or others can be added in the near-field communication chip for directly uploading to the cloud platform to build the relationship of the carrier, manufacturer and user with the near-field communication chip, or replace the near-field communication chip with a RFID chip, etc. Thus, all such variations and equivalent modifications are also embraced within the scope of the invention as defined in the appended claims.

What is claimed is:

1. An integrated system of goods or services comprising:
a carrier;
a first near-field communication chip having a first identification code;
a cloud platform having a first authentication data and a first goods or services data, the first authentication data and the first identification code having a first correspondence, the first goods or services data and the first authentication data having a first relationship; and
a mobile application program product capable of being installed in and executed on a mobile device having a near-field communication sensing module,
wherein when the carrier, the first near-field communication chip and the mobile device are within an operating area range, the near-field communication sensing module is triggered by the first near-field communication chip to retrieve the first identification code, and the first identification code is wirelessly transmitted to the cloud platform through the mobile device; when the first identification code matches with the first correspondence, the first goods or services data matching with the first relationship are wireless transmitted to the mobile device and executed on the mobile device via the mobile application program product.

2. The integrated system of goods or services according to claim 1, wherein the first authentication data includes a first qualification authentication data and a first validation authentication data, and the first goods or services data includes a first qualification goods or services data and a first validation goods or services data; the first identification code and the first qualification authentication data have a first qualification correspondence, and the first identification code and the first validation authentication data have a first validation correspondence; the first qualification authentication data and the first qualification goods or services data have a first qualification relationship, and the first validation authentication data and the first validation goods or services data have a first validation relationship; the cloud platform wirelessly transmits the first qualification goods or services data matching with the first qualification relationship, or the first validation goods or services data matching with the first validation relationship to be executed on the mobile device via the mobile application program product.

3. The integrated system of goods or services according to claim 1, further comprising a recording and storing database, an environment data of the mobile device being wirelessly transmitted to the recording and storing database via the mobile application program product, wherein the environment data includes mobile device identification data, time data, location data or application program parameter data.

4. The integrated system of goods or services according to claim 3, wherein the first goods or services data includes a carrier data which includes a carrier serial number, a carrier classification, a carrier name, a carrier configuration, an industrial classification, a carrier keyword, a chip installation date, an effective date, a service connection or content, an application classification or a contact person.

5. The integrated system of goods or services according to claim 4, further comprising an advertisement database with advertisement data and an operation analysis unit, the advertisement data including an advertising code, source, catalog and keyword, a fee-charging advertisement, an exhibition and selling location, a storage volume and model number for the advertising physical product, an advertisement broadcasting characteristic code, or an advertising content or connection, wherein the operation analysis unit performs an operation to analyze the advertisement data, the carrier data and the recording and storing database, through a keyword comparison, to broadcast the advertisement data on the mobile application program product.

6. The integrated system of goods or services according to claim 1, further comprising an identification serial number in the operating area range, the goods or services data including an identification serial number data corresponding to the identification serial number.

7. The integrated system of goods or services according to claim 1, wherein the carrier and the first near-field communication chip are dividably secured with each other.

8. The integrated system of goods or services according to claim 1, wherein the carrier and the first near-field communication chip are undividably secured with each other; if the carrier and the first near-field communication chip are separated, the near-field communication sensing module is not able to sense and retrieve the first identification code anymore.

9. The integrated system of goods or services according to claim 1, further comprising a second near-field communication chip having a second identification code within the operating area range, wherein the authentication data further include a second authentication data, and the goods or services data 42 further include a second goods or services data; the second authentication data and the second identification code have a second correspondence, and the second goods or services data and the second authentication data have a second relationship;
the cloud platform receives the second identification retrieved by the mobile device, and when the second identification matches the second correspondence, the second goods or services data matched with the second relationship is wirelessly transmitted and executed on the mobile device via the mobile application program product.

10. An integrated system of goods or services comprising:
a plurality of carriers;
a plurality of near-field communication chips, each near-field communication chip having an identification code, different near-field communication chips having different identification codes;
a cloud platform having a plurality of authentication data and a plurality of goods or services data, each authentication data and each identification code having a correspondence, each goods or services data and each authentication data having a relationship;
a plurality of mobile devices, each having a near-field communication sensing module; and
a mobile application program product capable of being installed in and executed on the mobile devices,
wherein when any one of the carriers, any one of the near-field communication chips and any one of the mobile devices are within an operating area range, the near-field communication sensing module is triggered by the near-field communication chip to retrieve the identification code, and the identification code is wirelessly transmitted to the cloud platform through the mobile device; when the identification code matches the correspondence, the goods or services data matching the relationship is wireless transmitted to the mobile device and executed on the mobile device via the mobile application program product.
